(19) United States
(12) Patent Application Publication
(10) Pub. No.: US 2022/0107773 A1
(43) Pub. Date: Apr. 7, 2022

(54) METHODS AND APPARATUS FOR EXTERNAL DISPLAY POWER LOSS DETECTION

(71) Applicant: INTEL CORPORATION, Santa Clara, CA (US)

(72) Inventors: Arvind Tomar, Folsom, CA (US); Michael Hamann, Portland, OR (US); Shailendra Singh Chauhan, Bangalore (IN); Ratheesh Nair, Bangalore (IN)

(21) Appl. No.: 17/552,268

(22) Filed: Dec. 15, 2021

(30) Foreign Application Priority Data
Sep. 24, 2021 (IN) 202141043292

(51) Int. Cl. G06F 3/14; G06F 1/30; G06F 13/12

(52) U.S. Cl. CPC G06F 3/1423; G06F 13/12; G06F 1/30

(57) ABSTRACT

Methods and apparatus for external display power loss detection. An example non-transitory computer readable medium comprises instructions that, when executed, cause a machine to at least determine whether a physical connection is established between a source device and an external display. In response to detecting the physical connection between the source device and the external display, present an application window from the source device to the external display, receive signal inputs from the external display, compare a first signal input from the signal inputs and second signal input from the signal inputs, and determine whether a calculated difference between the first signal input and the second signal input exceeds a threshold value. In response to determining that the calculated difference exceeds the threshold value, present the application window via the source device automatically without user input.

### CROSS-REFERENCE TO RELATED APPLICATION

This patent claims benefit to Indian Provisional Patent Application No. 2021/41043292, which was filed on Sep. 24, 2021, and which is hereby incorporated herein by reference in its entirety. Priority to Indian Provisional Patent Application No. 2021/41043292 filed with the Intellectual Property of India on Sep. 23, 2021, is hereby claimed.

### FIELD OF THE DISCLOSURE

This disclosure relates generally to power loss detection, and, more particularly, to methods and apparatus for external display power loss detection.

### BACKGROUND

In recent years, the use of battery-powered devices and external displays to extend and/or render application windows to a secondary display has grown rapidly in popularity. Using, for example an HDMI connection, users can choose to mirror their primary and secondary displays or selectively extend certain application windows to a secondary display, lending a level of convenience that is adaptable to personal preference.

### BRIEF DESCRIPTION OF THE DRAWINGS

FIG. 1 is an example display system having an example power loss detection system in accordance with teachings disclosed herein.

FIG. 2 is a schematic illustration of the example power loss detection system of FIG. 1.

FIGS. 3-6 depict example schematic configurations of other example power loss detection systems disclosed herein.

FIG. 7 is a block diagram of an example implementation of an example sensing circuitry of the example power loss detection systems disclosed herein.

FIG. 8 is a flowchart representative of example machine readable instructions that may be executed to implement the example power loss detecting systems of FIGS. 1-7.

FIG. 9 is a block diagram of an example processing platform structured to execute the instructions of FIG. 8 to implement the example power loss detection systems of FIGS. 1-7.

FIG. 10 is a block diagram of an example implementation of the processor circuitry of FIG. 9.

FIG. 11 is a block diagram of another example implementation of the processor circuitry of FIG. 10.

The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular. In general, the same reference numbers will be used throughout the drawing(s) and accompanying written description to refer to the same or like parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein “substantially real time” refers to occurrence in a near instantaneous manner recognizing there may be real world delays for computing time, transmission, etc. Thus, unless otherwise specified, “substantially real time” refers to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Although battery-powered devices such as, for example, laptops, tablets, etc., include a primary display, such battery-powered electronic devices are often employed with external or secondary display devices. For example, users can choose to mirror a primary display of the battery-powered source device and the external display, or selectively extend one or more application windows to a secondary display, lending a level of convenience that is adaptable to personal preference. For example, battery-powered devices can couple to external displays (e.g., secondary monitors or external devices) via any connection including, but not limited to, a High-Definition Multimedia Interface (HDMI) connection, a Digital Visual Interface (DVI) connection, a Video Graphics Array (VGA) connection, etc.

Unlike the source devices disclosed herein, example external displays are non-battery powered devices (e.g., do not include a battery). In other words, the external displays disclosed herein do not include a secondary power source (e.g., a battery or other portable power source) to provide power when power from an outlet (e.g., an alternating current (AC) electrical outlet) is not available. Thus, absent power from an electrical outlet, the external displays disclosed herein cannot receive power and, thus, cannot operate or function. During a power failure, the external displays disclosed herein are non-functional while the battery-powered device are functional or operational by employing energy from the battery provided that the battery has charge to power the battery-powered device (or provided from some other power source not providing power to the external display). Thus, while the battery-powered devices can maintain power, the external displays lose power during a power failure.

As a result, when an external display operatively coupled to a battery-powered source device experiences a power failure (e.g., an AC power failure) without notice to the battery-powered source device, the extended one or more application windows of the source device are lost until the external display regains power due to the lack of recognition by the source device (e.g., a battery powered device) that the external display (e.g., a non-battery powered device) no longer has power. For example, external displays can serve as primary display for the source device. Thus, during a power failure at the external display, a user can lose control of an operating system as the primary display is inoperable. In some scenarios, a user has to manually recover the extended application windows (e.g., by updating a setting to assign the source device as the primary display). For example, HDMI displays do not notify a transmitting interface on a source device that the display has lost power.

To establish a physical connection between a source device and an external display, source devices often employ a Hot Plug Detection (HPD). However, HPD can be unreliable in instances where battery-powered source devices are connected to external displays because HPD systems detect a received signal input (e.g., voltage value is greater than zero volts). In cases where a battery-powered source device is connected to an external display, the battery of the source device can provide a small amount of power to the external display via the connection. For example, commonly, a HPD of an external display receives voltage (e.g., a 5 volt) through a connection cable (e.g., an HDMI cable). Thus, so long as the source device is powered, and a cable is connected to the source device, HPD will remain asserted. As a result, the external display registers a voltage value greater than zero volts to the source device. In turn, the source side erroneously detects that the external display is connected to power and, thus, continues to route applications and/or windows to the external display for display or presentation. In other words, the external display, despite no longer receiving power from the electrical outlet, may still register as operational by the battery-powered device by way of a voltage provided by the battery of the source device across the connection between the two devices (e.g., the HDMI connection). While the detected voltage across the connection between the devices is insufficient to provide power to operate the external display, the measured voltage is sufficient to register the external display as operational with the source device. Thus, the source device attempts to display a windows application (e.g., a windows-based operating system) to the external display despite the external display having lost power (e.g., the external display being in a non-functional state).

Thus, current approaches to detect power loss via a connection between the source and the external display (e.g., via a hot plug detection (HPD) using a connection such as an HDMI connection) run the risk of failing to establish that an external display has lost connection when it is connected to a battery-powered source device. For example, power provided to a connection cable (e.g., an HDMI cable) from the battery of the source device causes power loss detection systems of the source device to erroneously identify that an external display has power during a power failure of the external display. In other words, the power loss detection systems of source devices are tricked into identifying that the external display has power and do not notify the source device of a power loss event on an external display. This proves to be unhelpful in mitigating loss of application window control when an external display loses power.

Example methods and apparatus disclosed herein establish a connection between a battery-powered source device and an external display, monitor one or more physical characteristics of the connection between the devices (e.g., voltage, current, etc.), determine whether the external display has lost power, and reroute (e.g., automatically) the extended application window(s) back to the source device in response to detecting a power failure at the external display. Detecting power loss in an external display allows for the reliable use of secondary displays, without loss of control during a power failure.

Examples disclosed herein utilize power loss detection techniques such as, for example, hot plug detection (HPD), voltage measurement, current measurement, etc. to assist with external display power loss detection. Typically, a source device can operatively couple to an external display via a connection including, but not limited to, High Definition Multimedia Interface (HDMI), Digital Virtual Interface (DVI), Video Graphics Array (VGA), display port (DP), and/or any other suitable connection(s). The examples disclosed herein employ HDMI connections. However, examples disclosed herein can be applied to other connections including, but not limited to, DVI, VGA, DP, and/or any other connection(s).

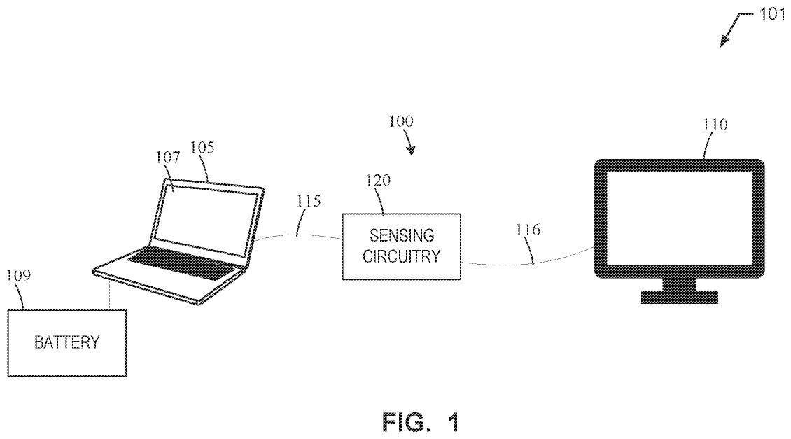

FIG. 1 illustrates an example display system 101 disclosed herein having a power loss detection system 100 in accordance with teachings disclosed herein. The example display system 101 of FIG. 1 includes a source device 105 (e.g., a laptop) coupled to an external display 110 (e.g., a computer monitor, an external display) via a connection 115 (e.g., a connection cable, a wired connection, etc.).

The source device 105 of the illustrated example is a battery-powered device and includes a battery 109 (e.g., a rechargeable battery). In the illustrated example, the source device 105 includes a first or source display 107 (e.g., a primary display, an LCD display, a touch screen display, etc.). The external display 110 of the illustrated example includes is secondary display (e.g., an LCD display, an LED display, a touch screen display, etc.). In some examples, the external display 110 can be employed as a primary display and the source display 107 of the source device 105 can be employed as a secondary display.

The example connection 115 of the illustrated example is an HDMI connection 116 (e.g., an HDMI cable). While the example of FIG. 1 communicatively couples the electric devices via the HDMI connection 116, in some examples any one or more connections may be utilized. For example, the connection 115 between the source device 105 and the external display 110 may be implemented by any other connection including, but not limited to, a VGA connection, DVI connection, DisplayPort connection, USB Type-C connection, and/or any other connection or cable for communicatively coupling two or more electronic devices.

The example power loss detection system 100 of FIG. 1 includes an example sensing circuitry. The sensing circuitry 120 of the illustrated example identifies and/or monitors a connection between the source device 105 and the external display 110. To detect power loss to the external display 110, the sensing circuitry 120 of the illustrated example monitors one or more physical characteristics of the connection 115 between the source device 105 and the external display 110. In some examples, after detection of a power loss to the external display 110, the sensing circuitry 120 reroutes (e.g., automatically) an extended application window that was displayed on the external display 110 prior to the power loss back to the source device 105.

The source device 105 of the illustrated example can be any personal, battery-powered device with a source display that is capable of connecting to an external device or display using a connection cable (e.g., HDMI connection). In examples disclosed herein, the source device 105 is represented as a laptop. However, in other examples, any other type of battery powered device (e.g., a mobile phone, tablet, etc.) can be utilized in conjunction with the example sensing circuitry 120 for external display power loss detection.

The external display 110 of the illustrated example can be a display device that is capable of connecting to a source device (e.g., the source device 105) using a connection cable (e.g., the HDMI connection 116). In examples disclosed herein, the external display 110 is a computer monitor. However, in other examples, any other type of external display (e.g., an LCD screen, tablet, etc.) may be utilized in conjunction with the example sensing circuitry 120 for external display power loss detection. Although the external display 110 shown in the example FIG. 1 is a single display, in some examples, a plurality of external displays and/or other external devices (e.g., multiple computer monitors) can operatively couple to the source device 105 (e.g., contemporaneously).

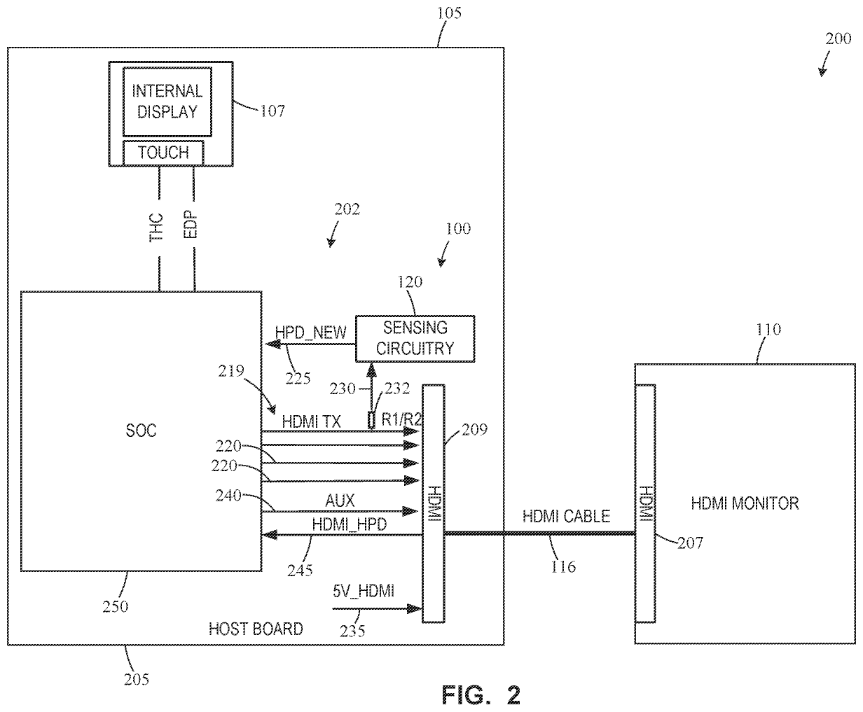

FIG. 2 is a schematic illustration of the example power loss detection system 100 and the display system 101 of FIG. 1. The source device 105 of the illustrated example includes electronic components 202 that provide instructions to display information, applications, windows and/or other graphics to a user via the source display 107. The electronic components 202 of the illustrated example include, but are not limited to, a printed circuit board (PCB) 205 (e.g., a host board), a system on chip (SOC) 250, and a first HDMI connector 209 (e.g., an input/output connector). The SOC 250 communicates (e.g., sends and/or receives) information (e.g., signals) with the first HDMI connector 209 via a plurality of HDMI communication channels 219 (e.g., circuitry). The HDMI communication channels 221 of the illustrated example includes a plurality of HDMI TX channels 220, an HDMI AUX channel 240, and an HDMI_HPD channel 245. The HDMI TX channels 220 serve as generalized communication channels between the source device 105 and the external display 110 for sending and/or receiving voltage, external display status queries, etc.

The external display 110 of the illustrated example includes a second HDMI connector 207 (eg. an input/output connector) to communicatively couple to the source device 105. For example, the HDMI connection 116 (cable) communicatively couples the source device 105 and the external display 110 such that the SOC 250 of the source device 105 instructs, commands, or causes the external display 110 to display one or more applications, programs, graphics, etc. via the HDMI connection 116.

The sensing circuitry 120 of FIG. 1 is located inside a housing of the source device 105. For example, the sensing circuitry 120 of the illustrated example is supported by the PCB 205 (e.g., a host board) of the source device 105 and is operatively and/or electrically coupled to the HDMI communication channels 219. Additionally, the sensing circuitry 120 of the illustrated example is operatively coupled to the external display 110 via the HDMI connection 116 when the HDMI cable is coupled to the first HDMI connector 209 and the second HDMI connector 207.

The SOC 250 commands or provides instructions to the source display 107 of the source device 105 and the external display 110. For example, the SOC 250 employs the HDMI connection 116 to communicate information, command(s), signal(s), etc., between the source device 105 and the external display 110. Thus, SOC 250 communicates commands or signals to the first HDMI connector 209 via the HDMI communication channels 219 and the first HDMI connector 209 transmits the commands and/or signals to the second HDMI connector 207 of the external display 110 via the HDMI connection 116. In turn, the external display 110 communicates signals to the SOC 250 of the source device 105 via the HDMI connection 116.

The SOC 250 additionally receives input from the HDMI_HDP channel 245 and provides data to the external display 110 using the HDMI AUX channel 240 and the HDMI connection 116. The HDMI_HPD channel 245 provides a hot plug detect channel employed by the source device 105 to detect a physical connection with the external display 110. The HDMI AUX channel 240 queries a status of the external display 110 when a potential power loss event has been detected by the sensing circuitry 120. For instance, the SOC 250 sends a signal across the HDMI AUX channel 240 to the external display 110 and determines whether the external display 110 provides a response to a signal propagated by the source device 105 to the external display 110. If the external display 110 does not respond, the source device 105 sets a status of the external display 110 as “not responding”. If the external display 110 responds, the source device 105 sets a status of the external display 110 as “responding.”

The sensing circuitry 120 senses for a potential power loss of the external display 110. To sense for a potential power loss, the sensing circuitry 120 of the illustrated example works in conjunction with the HDMI transmit (TX) channels 220. A five volt power supply line 235 provides power to the HDMI connection 116 (e.g., the first HDMI connector 209). In turn, the sensing circuitry 120 monitors or receives voltage values from the HDMI transmit (TX) channels 220. In other words, the sensing circuitry 120 of the illustrated example receives voltage values as an input signal 230 for analysis by the sensing circuitry 120 for power loss detection. Additionally, the sensing circuitry 120 of the illustrated example is communicatively coupled to the hot plug detection (HPD) module 225. The HPD module 225 monitors the existence of voltage values received by the source device 105 from the external display 110 via the HDMI TX channels 220. If the source device 105 receives a voltage value that meets (e.g., a value equals or exceeds a min threshold, a value equals or is below a max threshold, etc.) a threshold (e.g., zero volts), the HPD module 225 alerts the source device 105 to a physical connection between the source device 105 and the external display 110.

The sensing circuitry 120 of the illustrated example includes a filter 232 (e.g., a resistor R1/R2 component) that filters the physical connection characteristic (e.g., voltage value) from the range of input/output provided to and from the HDMI TX channels 220. The filtered physical connection characteristic is then provided to the sensing circuitry 120 as an input signal 230 (e.g., a filtered input signal) for monitoring and/or evaluation.

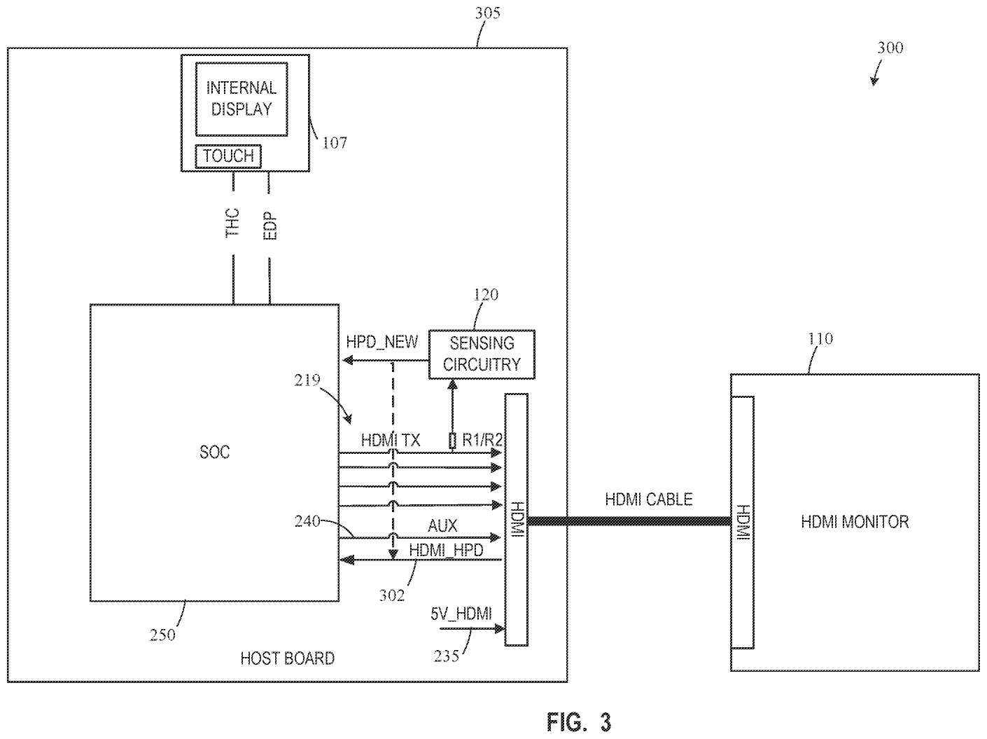

FIGS. 3-6 illustrate example schematic illustrations of example power loss detection systems 300-600 disclosed herein that can implement the example power loss detection system 100 of FIGS. 1 and 2. For example, the power loss detection systems 300-600 of FIGS. 3-6 illustrate various configurations of the sensing circuitry 120 of FIGS. 1 and 2 that may be used to implement the example power loss detection systems 300-600. Many of the components of the example power loss detection systems 300-600 of FIGS. 3-6 are substantially similar or identical to the components described above in connection with FIGS. 1 and 2. As such, those components will not be described in detail again below. Instead, the interested reader is referred to the above corresponding descriptions for a complete written description of the structure and operation of such components. To facilitate this process, similar or identical reference numbers will be used for like structures in FIGS. 3-6, including those used in FIGS. 1 and 2. Thus, a component with similar or identical reference numbers in FIGS. 3-6 will be used for like or identical structures. For example, each of the example power loss detection systems 300-600 employ sensing circuitry 120.

FIG. 3 is a schematic illustration of an example power loss detection system 300 disclosed herein. FIG. 3 is substantially similar to the example power loss detection system 200 of FIG. 2 except that the sensing circuitry 120 sends a power loss detection signal to an HDMI_HPD channel 302 (e.g., instead of the SOC 250 as shown in FIG. 2), which communicates the power loss event with a SOC 250 of a source device 305. In turn, the SOC 250 reroutes the application windows from the external display 110 back to the source device 305 when the sensing circuitry 120 detects a power loss at the external display 110.

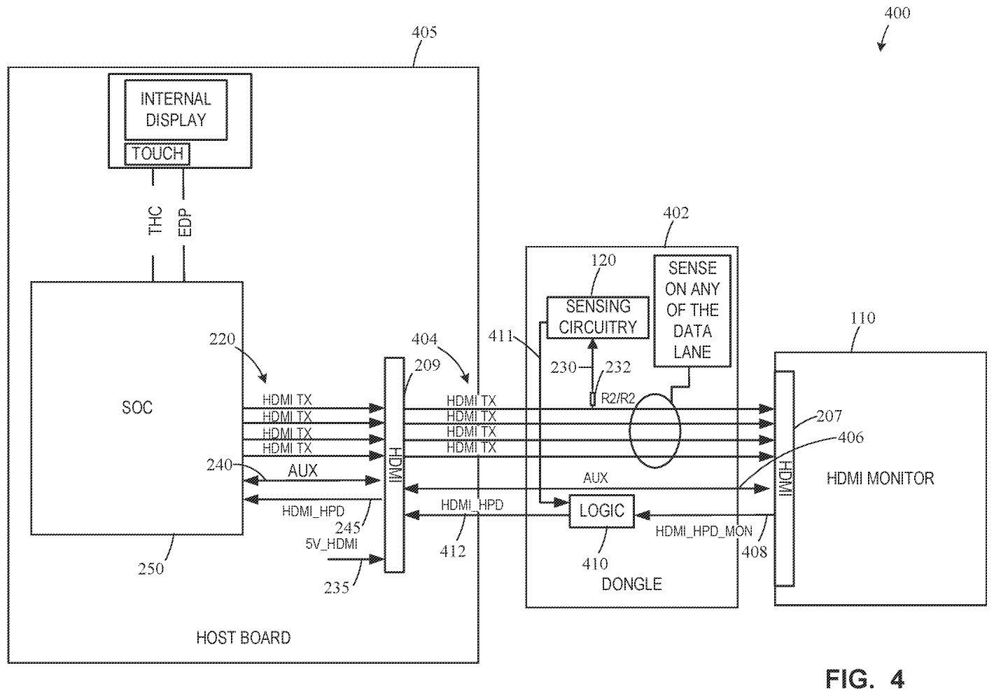

FIG. 4 is a schematic illustration of an example power loss detection system 400 disclosed herein. In the illustrated example, the sensing circuitry 120 is located or carried on an external dongle 402 that can physically attach and remove between the source device 405 and the external display 110. The dongle 402 of the illustrated example removably couples to a first HDMI connector 209 of the source device 405 and the second HDMI connector 207 of the external display 110. The dongle 402 of the illustrated example includes HDMI TX channels 404 that communicate with and/or correspond with the HDMI TX channels 220 of the source device 405. The dongle 402 includes an AUX channel 406 that communicates with the HDMI AUX channel 240 of the source device 405.

Additionally, the dongle 402 of the illustrated example includes an HDMI_HPD_MON channel 408 that communicates with the second connector 207 of the external display 110. Specifically, the HDMI_HPD_MON channel 408 is an input signal provided to a logic circuitry 410 of the dongle 402. For example, the input signal of the illustrated example measures a voltage of the second HDMI connector 207. The sensing circuitry 120 is substantially similar or identical to the sensing circuitry 120 of FIG. 2. For example, the sensing circuitry 120 within the dongle 402 of the illustrated example receives an input signal 230 (e.g., voltage value, a filtered signal) from the HDMI_TX channels 220. The sensing circuitry 120 includes a filter 232 (e.g., a resistor R1/R2 component) that filters the physical connection characteristic (e.g., voltage value(s)) from the range of input/output provided to and from the HDMI TX channels 220. The filtered input signal 230 (e.g., filtered physical connection characteristic) is then provided to the sensing circuitry 120 as the input signal 230 for monitoring and/or evaluation. The sensing circuitry 120 further calculates delta values between the input signal 230 (e.g., voltage value), determines if the delta values exceed a threshold value (e.g., 120 volts), and provides an input signal 411 (e.g., “true” or “false” value a binary value, etc.) to the logic circuit 410 based on the determination of whether the delta values exceed the threshold value (e.g., binary value “1” when a delta value exceeds the threshold and a binary value “0” when the delta value does not exceed the threshold). In examples disclosed herein, the logic circuitry 410 is a logical OR circuit, performing an OR combination of the input signal 411 and the input from the HDMI_HPD_MON channel 408. The HDMI_HPD channel 412 relays the output of the logic circuit 410 to the first HDMI connector 209 of the source device 405. In examples disclosed herein, if the HDMI_HPD channel 412 reports an indication of a power loss event (e.g., “true”), the SOC 250 is notified accordingly, and the extended application windows are rerouted back to the source device 405.

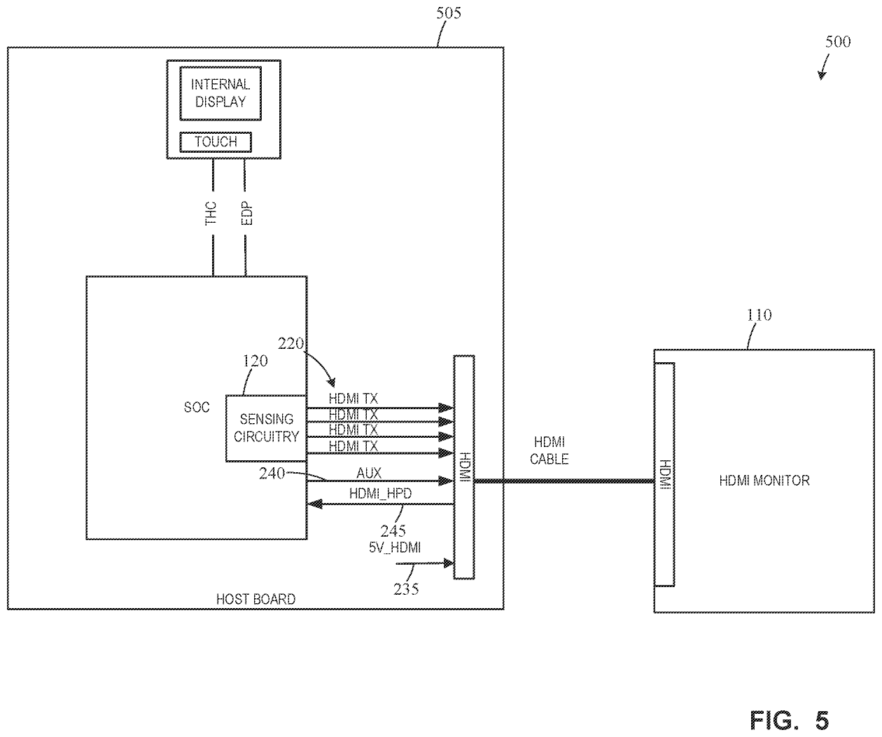

FIG. 5 is a schematic illustration of an example power loss detection system 500 disclosed herein. FIG. 5 is substantially similar to the example power loss detection system 200 of FIG. 2 except that the sensing circuitry 120 is located within the SOC 250. In this illustration, instead of acting as an intermediary between the HDMI communication channels 219 (e.g., HDMI TX channels 220, HDMI AUX channel 240, HDMI_HPD channel 245, etc.), the sensing circuitry 120 is integrally formed with the SOC 250.

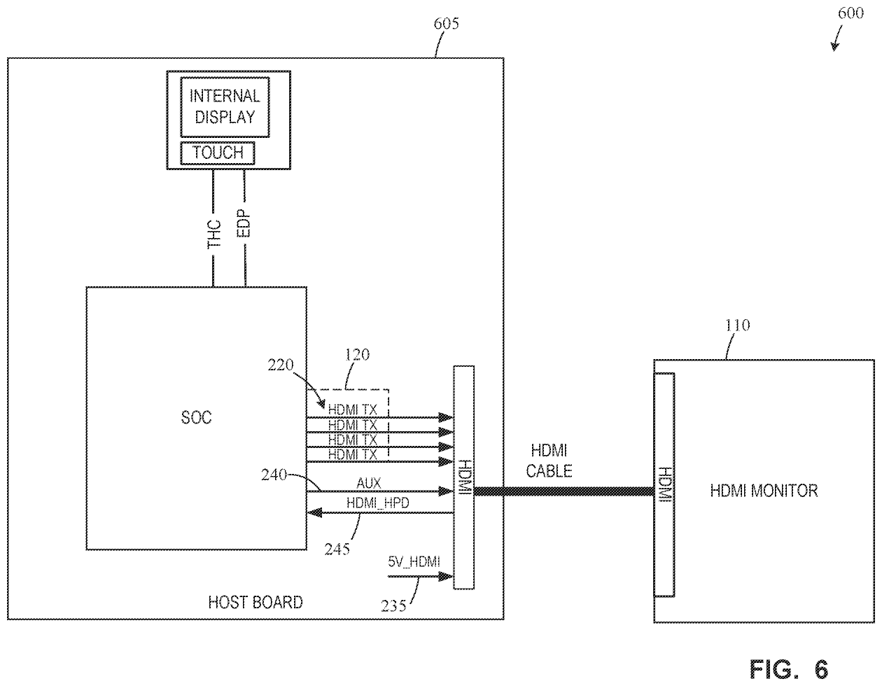

FIG. 6 is a schematic illustration of another example power loss detection system 600 disclosed herein. The power loss detection system 600 of the illustrated example utilizes polling to determine whether the external display 110 has experienced an AC power failure. In examples disclosed herein, polling is the frequent querying of a status of the external display 110 by the source device 605, via the HDMI AUX channel 240. In the illustrated example, the HDMI transmit (TX) channels 220 perform or define a sensing circuitry 120 (e.g., receiving and/or storing of voltage values, determination of power loss event, etc.). For example, the sensing circuitry 120 detects a change in voltage that is larger than a threshold value (e.g., 120 volts), while simultaneously determining that the external display 110 is no longer responding to the status queries sent via the HDMI AUX channel 240, allowing for a conclusive determination of a power loss event.

Although each example power loss detection systems 300-600 disclosed above have certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

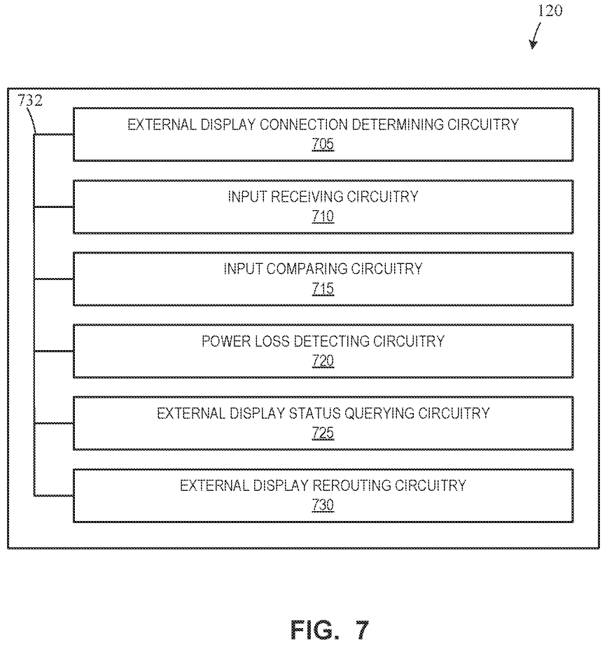

FIG. 7 illustrates an example implementation of the sensing circuitry 120 of FIGS. 1-6. The sensing circuitry 120 of the illustrated example includes an example external display connection determining circuitry 705, an example input receiving circuitry 710, an example input comparing circuitry 715, an example power loss detecting circuitry 720, an example external display status querying circuitry 725, and example external display rerouting circuitry 730. In the illustrated example, the example external display connection determining circuitry 705, the example input receiving circuitry 710, the example input comparing circuitry 715, an example power loss detecting circuitry 720, the example external display status querying circuitry 725, and the example external display rerouting circuitry 730 are communicatively coupled via a bus 732.

The example external display connection determining circuitry 705 establishes whether a connection has been made between a battery-powered source device (e.g., the source devices 105-605 of FIGS. 1-6) and an external display (e.g., the external display 110 of FIGS. 1-6) via a connection and/or cable (e.g., the connection 115). In examples disclosed herein, to establish whether a connection has been made between the source device and the external display, the external display connection determining circuitry 705 works in conjunction with the HPD module 225. The HPD module 225 evaluates whether voltage values provided across a shared connection between the source device and the external device meets (e.g., a value equals or exceeds a min threshold, a value equals or is below a max threshold, etc.) a threshold. For example, the threshold of the illustrated example is zero volts. However, in some examples, the threshold can be one volt, two volts, three volts, etc. If the voltage value meets (e.g., a value equals or exceeds a min threshold, a value equals or is below a max threshold, etc.) the threshold, the sensing circuitry 120 determines that a physical connection has been established between the devices. In the illustrated example, the external display connection determining circuitry 705 establishes whether a connection has been made between a source device and an external display via an HDMI connection (e.g., the HDMI connection 116 and/or the HDMI cable). However, in other examples, the external display connection determining circuitry 705 establishes whether a connection has been made between a battery-powered source device (e.g., the source devices 105-605 of FIGS. 1-6) and an external display (e.g., the external display 110 of FIGS. 1-6) via any other connection and/or cable including, for example, a USB connection, a DVI connection, DP connection, etc.

The example input receiving circuitry 710 receives a physical characteristic from the external display and stores the values for comparison. For example, the sensing circuitry 120 can include and/or can be communicatively coupled (e.g., via the bus 732) to memory. For example, the input receiving circuitry 710 receives the input signals 230 from the HDMI TX channel 220, the HDMI AUX channel 240, the HDMI_HPD channel 245, the HDMI TX 404, and the filter 232 (e.g., the R1/R2 component). In examples disclosed herein, the physical characteristic of connection that is measured and collected from the external display is voltage. Alternatively, current, or other characteristics can also be received and stored by the input receiving circuitry 710.

The example input comparing circuitry 715 receives an input signal 230 of a plurality of voltage values or signals 230 from the filter 232 (e.g., the R1/R2 component), as filtered from the input received by the HDMI TX channel 220. The example input comparing circuitry 715 then compares the difference in voltage values (or other physical characteristic of connection) received at different times as the input signals 230 from the external display 110 to calculate a delta value of voltage (e.g., sequential voltage values).

The example power loss detecting circuitry 720 determines whether a delta value of voltage calculated by the input comparing circuitry 715 exceeds the threshold (e.g., between approximately 100 volts and 300 volts, 110 volts, 120 volts, 200 volts, 220 volts, 240 volts, other power or voltage schemes, etc.) via a comparator circuitry located within the sensing circuitry 120. If the delta value of voltage is determined to meet (e.g., a value equals or exceeds a min threshold, a value equals or is below a max threshold, etc.) the threshold, an external display power loss event is indicated. In examples disclosed herein, the voltage values received by a source device from an external display when the external display is connected to power is typically in the range of 400-500 millivolts. When an external display has lost power, the received voltage values are typically about 1 volt. Thus, a power loss event causes a significant spike in the calculated delta value of voltage.

The example external display status querying circuitry 725 responds to a potential external display AC power fail event indicated by the power loss detecting circuitry 720 by querying the status of the external display through the HDMI AUX channel 240 of FIGS. 2-6. The status of the external display is queried by sending a signal through the HDMI AUX channel 240 to the external display. If the external display does not respond to the query, the external display status querying circuitry 725 determines that the external display has lost power.

The example external display rerouting circuitry 730 reroutes the application windows that have been extended to the external display back to the battery-powered source device to allow the user to regain control of the application windows after the power loss event by notifying the source device that the connection the external display is no longer valid. The source device, upon receiving this notification, will terminate the connection with the external display, thus causing the application windows to resume their normal states on the source device.

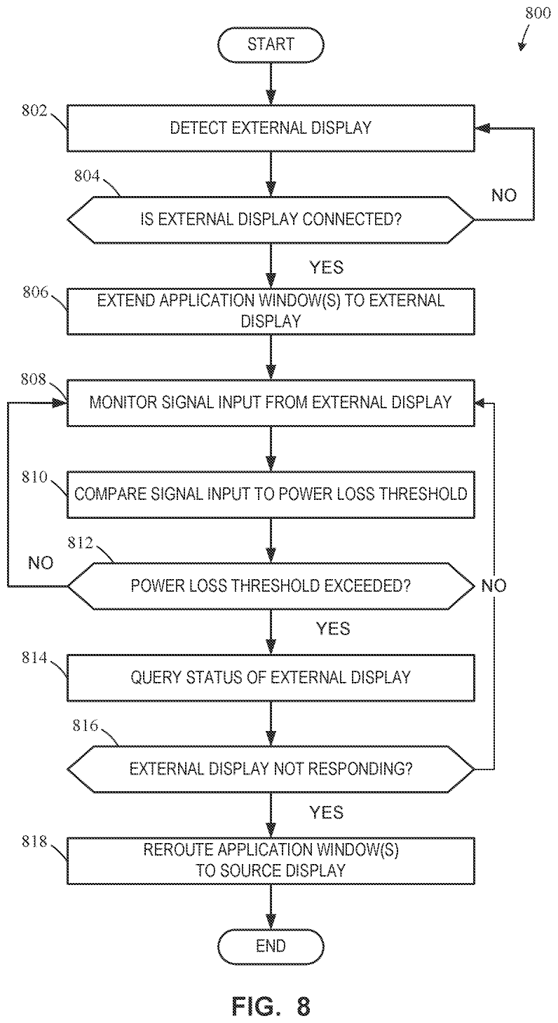

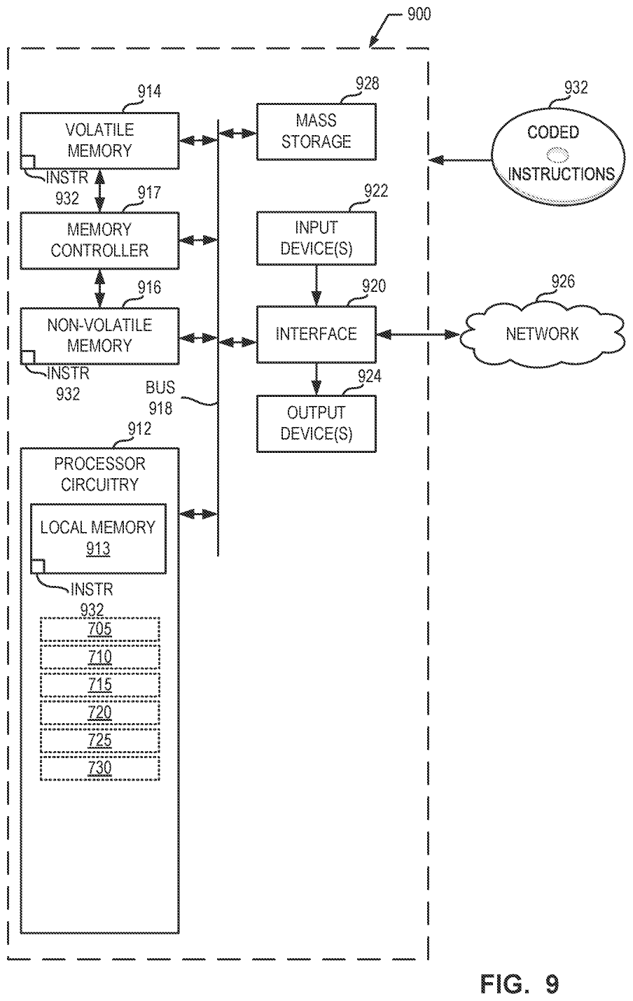

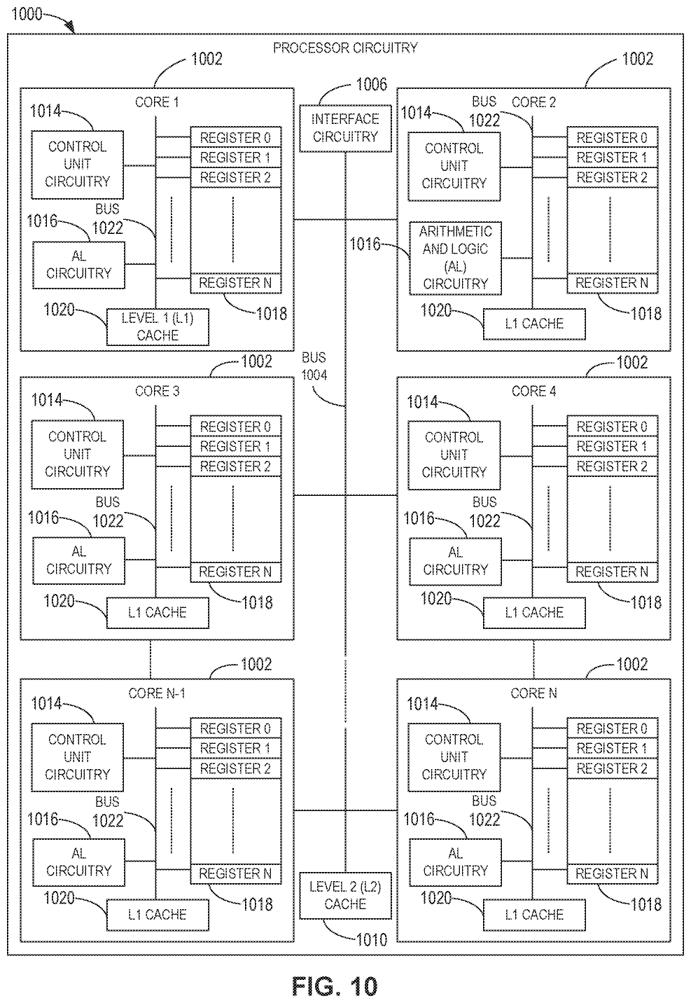

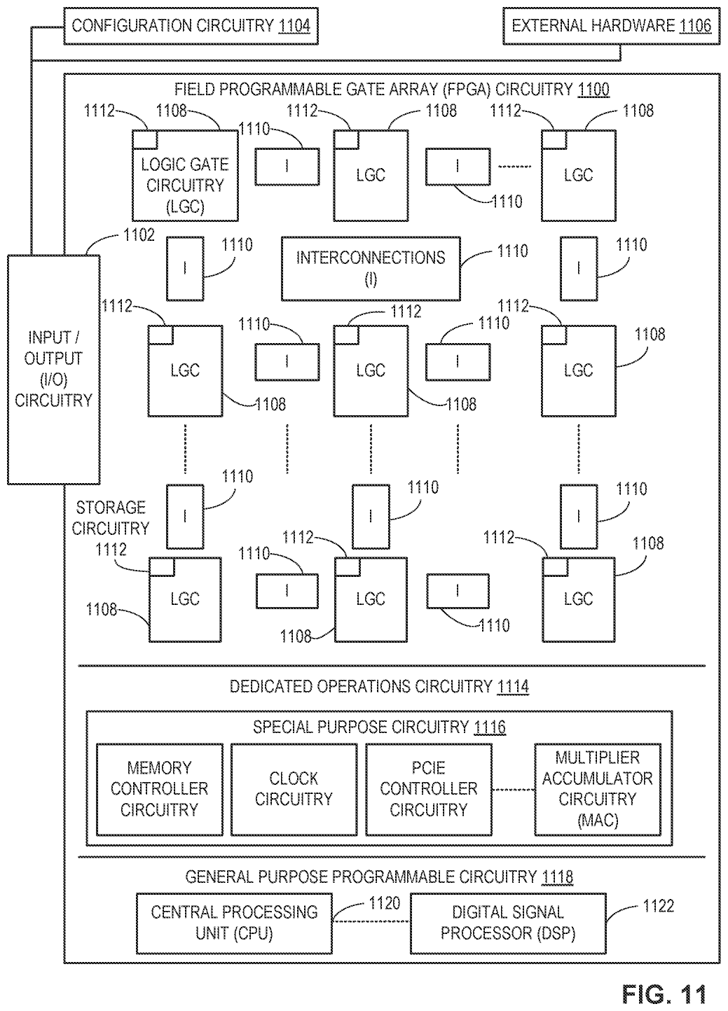

In some examples, the external display connection determining circuitry 705 includes means for determining whether a connection has been established between a battery-powered source device and an external display via an HDMI cable. For example, the means for determining whether a connection has been established between a battery-powered source device and an external display via an HDMI cable may be implemented by external display connection determining circuitry 705. In some examples, the external display connection determining circuitry 705 may be implemented by machine executable instructions such as that implemented by at least blocks 802, 804, 806 of FIG. 8 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the external display connection determining circuitry 705 is implemented by other hardware logic circuitry, hardware implemented state machines, and/or any other combination of hardware, software, and/or firmware. For example, the external display connection determining circuitry 705 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the input receiving circuitry 710 includes means for receiving and storing a characteristic of physical connection between the source device and the external display (e.g., voltage values). For example, the means for receiving and storing a characteristic of physical connection between the source device and the external display (e.g., voltage values) may be implemented by input receiving circuitry 710. In some examples, the input receiving circuitry 710 may be implemented by machine executable instructions such as that implemented by at least block 808 of FIG. 8 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the input receiving circuitry 710 is implemented by other hardware logic circuitry, hardware implemented state machines, and/or any other combination of hardware, software, and/or firmware. For example, the input receiving circuitry 710 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the input comparing circuitry 715 includes means for comparing the received voltage values (or other characteristics of physical connection) against one another. For example, the means for comparing the received voltage values (or other characteristics of physical connection) against one another may be implemented by input comparing circuitry 715. In some examples, the input comparing circuitry 715 may be implemented by machine executable instructions such as that implemented by at least block 810 of FIG. 8 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the input comparing circuitry 715 is implemented by other hardware logic circuitry, hardware implemented state machines, and/or any other combination of hardware, software, and/or firmware. For example, the input comparing circuitry 715 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the power loss detecting circuitry 720 includes means for determining whether a delta of voltage values exceeds a threshold value indicating external display power failure. For example, the means for determining whether a delta of voltage values exceeds a threshold value indicating external display power failure may be implemented by power loss detecting circuitry 720. In some examples, the power loss detecting circuitry 720 may be implemented by machine executable instructions such as that implemented by at least block 812 of FIG. 8 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the power loss detecting circuitry 720 is implemented by other hardware logic circuitry, hardware implemented state machines, and/or any other combination of hardware, software, and/or firmware. For example, the power loss detecting circuitry 720 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the external display status querying circuitry 725 includes means for querying the status of an external display when a power loss event is suspected. For example, the means for querying the status of an external display when a power loss event is suspected may be implemented by external display status querying circuitry 725. In some examples, the external display status querying circuitry 725 may be implemented by machine executable instructions such as that implemented by at least blocks 814, 816 of FIG. 8 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, external display status querying circuitry 725 is implemented by other hardware logic circuitry, hardware implemented state machines, and/or any other combination of hardware, software, and/or firmware. For example, the external display status querying circuitry 725 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the external display rerouting circuitry 730 includes means for rerouting extended application windows from the external display back to the battery-powered source device when a power loss event has been confirmed. For example, the means for rerouting extended application windows from the external display back to the battery-powered source device when a power loss event has been confirmed may be implemented by external display rerouting circuitry 730. In some examples, the external display rerouting circuitry 730 may be implemented by machine executable instructions such as that implemented by at least block 818 of FIG. 8 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, external display rerouting circuitry 730 is implemented by other hardware logic circuitry, hardware implemented state machines, and/or any other combination of hardware, software, and/or firmware. For example, the external display rerouting circuitry 730 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example manner of implementing the external display power loss detecting system 100 of FIG. 1 is illustrated in FIG. 7, one or more of the elements, processes, and/or devices illustrated in FIG. 7 may be combined, divided, re-arranged, omitted, eliminated, and/or implemented in any other way. Further, the example external display connection determining circuitry 705, the example input receiving circuitry 710, the example input comparing circuitry 715, the example power loss detecting circuitry 720, the example external display status querying circuitry 725, the example external display rerouting circuitry and/or more generally the sensing circuitry 120 of FIGS. 1-7 and/or the example external display power loss detection systems 100, 300-600, may be implemented by hardware alone or by hardware in combination with software and/or firmware. Thus, for example, any of the example external display connection determining circuitry 705, the example input receiving circuitry 710, the example input comparing circuitry 715, the example power loss detecting circuitry 720, the example external display status querying circuitry 725, the example external display rerouting circuitry and/or more generally the sensing circuitry 120 of FIGS. 1-7, and/or, more generally, the example external display power loss detection systems 100, 300-600, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example external display power loss detection systems 100, 300-600 of FIGS. 1-7 may include one or more elements, processes, and/or devices in addition to, or instead of, those illustrated in FIG. 7, and/or may include more than one of any or all of the illustrated elements, processes and devices.

A flowchart representative of example hardware logic circuitry, machine readable instructions, hardware implemented state machines, and/or any combination thereof for implementing the sensing circuitry 120 of FIGS. 1-7 is shown in FIG. 8. The machine readable instructions may be one or more executable programs or portion(s) of an executable program for execution by processor circuitry, such as the processor circuitry 912 shown in the example processor platform 1000 discussed below in connection with FIG. 10 and/or the example processor circuitry discussed below in connection with FIG. 11 and/or 12. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 8, many other methods of implementing the example sensing circuitry 120 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 8 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine readable instructions and/or example operations 800 that may be executed and/or instantiated by processor circuitry to implement the sensing circuitry 120 of FIGS. 1-7 The machine readable instructions and/or operations 800 of FIG. 8 begin at block 802, at which the external display connection determining circuitry 705 detects a connection with an external display. For example, to detect the connection with the external display, the external display connection determining circuitry 705 determines if the HDMI AUX channel 240 is able to send and/or receive information from an external display. In examples disclosed herein, the physical connection between the source device 105, 305, 405, 505, 605 and the external display 110 is determined in association with the HPD module 225. The HPD module 225 receives a signal (e.g., a voltage) from a first HDMI connector 209 in communication with the external display via a cable. For example, if the voltage monitored meets (e.g., a value equals or exceeds a min threshold, a value equals or is below a max threshold, etc.) a threshold (e.g., zero volts), the HPD module 225 will establish that a physical connection has been made between the source device and the external display

At block 804, if the external display connection determining circuitry 705 establishes that a connection has not been made between a battery-powered source device and an external display, the process returns to block 802. At block 804, if the external display connection determining circuitry 705 establishes that a connection has been made between a battery-powered source device and an external display, the process moves to block 806.

At block 806, if a connection has been established between a battery-powered source device and an external display, the external display connection determining circuitry 705 communicates to the SOC 250 the existence of a physical connection between the source device and an external display. In turn, the SOC 250 extends one or more selected (e.g., user selected) application windows to the external display.

At block 808, the input receiving circuitry 710 monitors a signal input from the external display. In examples disclosed herein, the signal input from the external display refers to any characteristic of physical connection between the source device and the external display including, but not limited to, voltage, current, resistance, etc. For example, the input receiving circuitry 710 monitors the signal input (e.g., a voltage) from the filter 232. The filter 232, as mentioned above, filters the signal input from the range of input and/or output provided across the HDMI TX channel 220, the HDMI TX channels 404.

At block 810, the input comparing circuitry 715 of FIG. 7 compares consecutive signal input values (e.g., voltage values) to establish a delta between the input values using comparator circuitry within the sensing circuitry 120. In examples disclosed herein, the signal input values filtered and provided by the filter 232 over time should remain in a power loss threshold (e.g., in the same range) if the external display is connected to AC power. Should the external display experience an AC power fail, the signal input values (e.g., voltage values) drop significantly, causing a larger calculated delta between the measured values (e.g., between two consecutive values).

At block 812, the power loss detecting circuitry 720 of FIG. 7 compares the calculated delta values to a pre-determined threshold of power loss for the external display. In examples disclosed herein, a typical range of voltage values received when the external display is connected to AC power is 400-500 millivolts. When the external display is no longer connected to AC power, the voltage values received are reduced to around 1 volt. Thus, in examples disclosed herein, the threshold value of power loss for the external display is around 120 volts in the United States and 240 volts for the rest of the world (e.g., Europe, India, etc.).

If the power loss threshold has been exceeded at block 812, the external display status querying circuitry 725 queries the status of the external display to check if there is a response at block 814. The external display status querying circuitry 725 sends a status signal to the external display via the HDMI AUX channel 240. If the source device does not receive a feedback signal from the external display in response, the sensing circuitry 120 and/or the SOC 250 determines that the external display is no longer responsive.

At block 816, if the external display is not responding, the external display status querying circuitry 725 confirms the external display power loss event and proceeds to block 818. If the external display does respond, the process returns to block 808, wherein the signal input from the external display is monitored.

At block 818, once an external display power loss event has been confirmed, the external display rerouting circuitry 730 communicates the external display power loss event to the SOC 250, which then reroutes for presentation the one or more extended application windows to the battery-powered source device by terminating the connection between the source device and external display. In other words, the source device 105 presents the one or more application windows, that were previously presented via the external display 110, via the source device 105 (e.g., the source display 107) automatically without user input.

FIG. 9 is a block diagram of an example processor platform 900 structured to execute and/or instantiate the machine readable instructions and/or operations of FIG. 8 to implement the sensing circuitry 120 of FIGS. 1-7. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs microprocessors, CPUs, GPUs, DSPs, and/or microcontrollers from any desired family or manufacturer. The processor circuitry 912 may be implemented by one or more semiconductor based (e.g., silicon based) devices. In this example, the processor circuitry 912 implements the example external display connection determining circuitry 705, the example input receiving circuitry 710, the example input comparing circuitry 715, the example power loss detecting circuitry 720, the example external display status querying circuitry 725, and the example external display rerouting circuitry 730.

The processor circuitry 912 of the illustrated example includes a local memory 913 (e.g., a cache, registers, etc.). The processor circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 922 are connected to the interface circuitry 920. The input device(s) 922 permit(s) a user to enter data and/or commands into the processor circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuitry 920 of the illustrated example. The output devices 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 932, which may be implemented by the machine readable instructions of FIG. 8, may be stored in the mass storage device 928, in the volatile memory 914, in the non-volatile memory 916, and/or on a removable non-transitory computer readable storage medium such as a CD or DVD.

FIG. 10 is a block diagram of an example implementation of the processor circuitry 912 of FIG. 9. In this example, the processor circuitry 912 of FIG. 9 is implemented by a microprocessor 1000. For example, the microprocessor 1000 may implement multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowchart of FIG. 8.

The cores 1002 may communicate by an example first bus 1004. In some examples, the first bus 1004 may implement a communication bus to effectuate communication associated with one(s) of the cores 1002. For example, the first bus 1004 may implement at least one of an Inter-Integrated Circuit (I2C) bus, a Serial Peripheral Interface (SPI) bus, a PCI bus, or a PCIe bus. Additionally or alternatively, the first bus 1004 may implement any other type of computing or electrical bus. The cores 1002 may obtain data, instructions, and/or signals from one or more external displays by example interface circuitry 1006. The cores 1002 may output data, instructions, and/or signals to the one or more external displays by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2_cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the L1 cache 1020, and an example second bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core_02 to shorten access time. The second bus 1022 may implement at least one of an I2C bus, a SPI bus, a PCI bus, or a PCIe bus

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 11 is a block diagram of another example implementation of the processor circuitry 912 of FIG. 9. In this example, the processor circuitry 912 is implemented by FPGA circuitry 1100. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine readable instructions represented by the flowchart of FIG. 8 but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine readable instructions represented by the flowchart of FIG. 8 In particular, the FPGA 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowchart of FIG. 8. As such, the FPGA circuitry 1100 may be structured to effectively instantiate some or all of the machine readable instructions of the flowchart of FIG. 8 as dedicated logic circuits to perform the operations corresponding to those software instructions in a dedicated manner analogous to an ASIC. Therefore, the FPGA circuitry 1100 may perform the operations corresponding to the some or all of the machine readable instructions of FIG. 8 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware (e.g., external hardware circuitry) 1106. For example, the configuration circuitry 1104 may implement interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1106 may implement the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and interconnections 1110 are configurable to instantiate one or more operations that may correspond to at least some of the machine readable instructions of FIG. 8 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 912 of FIG. 9, many other approaches are contemplated. For example, as mentioned above, modern FPGA circuitry may include an on-board CPU, such as one or more of the example CPU 1120 of FIG. 11. Therefore, the processor circuitry 912 of FIG. 9 may additionally be implemented by combining the example microprocessor 1000 of FIG. 10 and the example FPGA circuitry 1100 of FIG. 11. In some such hybrid examples, a first portion of the machine readable instructions represented by the flowchart of FIG. 8 may be executed by one or more of the cores 1002 of FIG. 10 and a second portion of the machine readable instructions represented by the flowchart of FIG. 8 may be executed by the FPGA circuitry 1100 of FIG. 10.

In some examples, the processor circuitry 912 of FIG. 9 may be in one or more packages. For example, the processor circuitry 1000 of FIG. 10 and/or the FPGA circuitry 1000 of FIG. 10 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

From the foregoing, it will be appreciated that example systems, methods, apparatus, and articles of manufacture have been disclosed that extend the applications of detecting AC power loss events in external displays connected to a battery-powered source device via an HDMI cable. The disclosed systems, methods, apparatus, and articles of manufacture improve the efficiency of using a computing device by mitigating the loss of application window control after an unexpected external display power fail event that is not registered by a battery-powered source device. The disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to detect external display power loss are disclosed herein. Further examples and combinations thereof include the following:

Example 1 includes a non-transitory computer readable medium comprising instructions that, when executed, cause a machine to at least in response to detecting a physical connection between a source device and an external display, present an application window from the source device to the external display, compare a first signal input and a second signal input received from the external display, determine whether a calculated difference between the first signal input and the second signal input meets a threshold, and in response to determining that the calculated difference meets the threshold, present the application window via the source device automatically without user input.

Example 2 includes the non-transitory computer readable medium of example 1, wherein at least one of the first signal input or the second signal input include at least one of voltage or current.

Example 3 includes the non-transitory computer readable medium of example 1, wherein the threshold value for external display power loss detection is less than 110 volts.

Example 4 includes the non-transitory computer readable medium of example 1, wherein the instructions cause the machine to send a power loss detection signal to a Hot Plug Detection (HPD) channel.

Example 5 includes the non-transitory computer readable medium of example 4, wherein the instructions cause the machine to send status queries to the external display to check for responsiveness.

Example 6 includes an apparatus to determine a power loss event in an external display when coupled to a source device, the apparatus comprising processor circuitry including one or more of at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations according to instructions, and one or more registers to store a result of the one or more first operations, the instructions in the apparatus, a Field-Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrate Circuitry (ASIC) including logic gate circuitry to perform one or more third operations, the processor circuitry to perform at least one of the first operations, the second operations or the third operations to instantiate interface circuitry to establish a connection has been made between a battery-powered source device and the external display, input comparing circuitry to compare a first signal input and second signal input from the external display to calculate a delta signal, power loss detecting circuitry to determine whether the delta signal meets a threshold value, external display status querying circuitry to query a status of the external display after the delta signal has been determined to meet the threshold value, and external display rerouting circuitry to reroute one or more application windows via the source device automatically without user input.

Example 7 includes the apparatus of example 6, wherein the external display rerouting circuitry is to cause presentation of the one or more application windows by the source device automatically without user input.

Example 8 includes the apparatus of example 6, wherein the signal inputs including at least one of a voltage or current.

Example 9 includes the apparatus of example 6, wherein the interface circuitry establishes a connection between the source device and the external display using characteristics associated with an HDMI connection.

Example 10 includes the apparatus of example 6, wherein the processor circuitry is located within an external dongle coupled between the source device and external display.

Example 11 includes the apparatus of example 10, wherein the external dongle is coupled to a first connector of the source device and a second connector of the external display.

Example 12 includes the apparatus of example 6, wherein the processor circuitry is located within a System on Chip (SOC) of the source device.

Example 13 includes a method to determine a power loss event in an external display comprising determining a physical connection between a source device and an external display, in response to detecting the physical connection between the source device and the external display, extending one or more application windows from the source device to the external display, receiving signal inputs from the external display, comparing a first signal input and a second signal input from the signal inputs, determining whether a calculated difference between the first signal input and the second signal input exceeds a threshold value, and in response to determining that the calculated difference exceeds the threshold value, rerouting the one or more application windows from the external display to the source device.

Example 14 includes the method of example 13, further including establishing the physical connection between the source device and the external display via an HDMI connection.

Example 15 includes the method of example 13, wherein the signal inputs received from the external display include at least one of voltage or current.

Example 16 includes the method of example 13, wherein the threshold value for external display power loss detection is less than 110 volts.

Example 17 includes the method of example 13, further including sending a power loss detection signal to a Hot Plug Detection (HPD) channel.

Example 18 includes the method of example 13, further including coupling a dongle to a first connector of the source device and a second connector of the external display, the dongle including a sensing circuitry.

Example 19 includes the method of example 13, wherein the rerouting the one or more application windows from the external display to the source device include presenting the one or more application windows via the source device automatically without user involvement.

Example 20 includes the method of example 13, further including sending status queries to the external display to check for responsiveness in response to the calculated difference exceeding the threshold value.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A non-transitory computer readable medium comprising instructions that, when executed, cause a machine to at least:
in response to detecting a physical connection between a source device and an external display, present an application window from the source device to the external display;
compare a first signal input and a second signal input received from the external display;
determine whether a calculated difference between the first signal input and the second signal input meets a threshold; and
in response to determining that the calculated difference meets the threshold, present the application window via the source device automatically without user input.

2. The non-transitory computer readable medium of claim 1, wherein at least one of the first signal input or the second signal input include at least one of voltage or current.

3. The non-transitory computer readable medium of claim 1, wherein the threshold value for external display power loss detection is less than 110 volts.

4. The non-transitory computer readable medium of claim 1, wherein the instructions cause the machine to send a power loss detection signal to a Hot Plug Detection (HPD) channel.

5. The non-transitory computer readable medium of claim 4, wherein the instructions cause the machine to send status queries to the external display to check for responsiveness.

6. An apparatus to determine a power loss event in an external display when coupled to a source device, the apparatus comprising:
processor circuitry including one or more of:
at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations according to instructions, and one or more registers to store a result of the one or more first operations, the instructions in the apparatus;
a Field-Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or
Application Specific Integrate Circuitry (ASIC) including logic gate circuitry to perform one or more third operations;
the processor circuitry to perform at least one of the first operations, the second operations or the third operations to instantiate:
interface circuitry to establish a connection has been made between a battery-powered source device and the external display;
input comparing circuitry to compare a first signal input and second signal input from the external display to calculate a delta signal;
power loss detecting circuitry to determine whether the delta signal meets a threshold value;
external display status querying circuitry to query a status of the external display after the delta signal has been determined to meet the threshold value; and
external display rerouting circuitry to reroute one or more application windows via the source device automatically without user input.

7. The apparatus of claim 6, wherein the external display rerouting circuitry is to cause presentation of the one or more application windows by the source device automatically without user input.

8. The apparatus of claim 6, wherein the signal inputs including at least one of a voltage or current.

9. The apparatus of claim 6, wherein the interface circuitry establishes a connection between the source device and the external display using characteristics associated with an HDMI connection.

10. The apparatus of claim 6, wherein the processor circuitry is located within an external dongle coupled between the source device and external display.

11. The apparatus of claim 10, wherein the external dongle is coupled to a first connector of the source device and a second connector of the external display.

12. The apparatus of claim 6, wherein the processor circuitry is located within a System on Chip (SOC) of the source device.

13. A method to determine a power loss event in an external display comprising:
determining a physical connection between a source device and an external display;
in response to detecting the physical connection between the source device and the external display, extending one or more application windows from the source device to the external display;
receiving signal inputs from the external display;
comparing a first signal input and a second signal input from the signal inputs;
determining whether a calculated difference between the first signal input and the second signal input exceeds a threshold value; and
in response to determining that the calculated difference exceeds the threshold value, rerouting the one or more application windows from the external display to the source device.

14. The method of claim 13, further including establishing the physical connection between the source device and the external display via an HDMI connection.

15. The method of claim 13, wherein the signal inputs received from the external display include at least one of voltage or current.

16. The method of claim 13, wherein the threshold value for external display power loss detection is less than 120 volts.

17. The method of claim 13, further including sending a power loss detection signal to a Hot Plug Detection (HPD) channel.

18. The method of claim 13, further including coupling a dongle to a first connector of the source device and a second connector of the external display, the dongle including a sensing circuitry.

19. The method of claim 13, wherein the rerouting the one or more application windows from the external display to the source device include presenting the one or more application windows via the source device automatically without user involvement.

20. The method of claim 13, further including sending status queries to the external display to check for responsiveness in response to the calculated difference exceeding the threshold value.
